(19) United States
(12) Patent Application Publication
(10) Pub. No.: US 2010/0207537 A1
(43) Pub. Date: Aug. 19, 2010

(54) COMPLEX FLUORESCENT LAMP

(75) Inventor: Yi-Chao Chiang, Zhubei City (TW)

Correspondence Address: RABIN & Berdo, PC, 1101 14TH STREET, NW, SUITE 500, WASHINGTON, DC, 20005, US

(73) Assignee: Verticil Electronics Corp., Hsinchu City (TW)

(21) Appl. No.: 12/493,618

(22) Filed: Jun. 29, 2009

(30) Foreign Application Priority Data
Feb. 18, 2009 (TW) 098105183

(51) Int. Cl. H05B 41/16

(52) U.S. Cl. 315/276

(57) ABSTRACT

A complex fluorescent lamp is provided. The complex fluorescent lamp comprises at least one cold cathode fluorescent lamp (CCFL) and an impedance transformer. Each of the CCFL has a first electrode and a second electrode. The impedance transformer is coupled to the first electrode and the second electrode for transforming an AC signal into a high voltage signal to light up the at least one CCFL.

This application claims the benefit of Taiwan application Serial No. 98105183, filed Feb. 18, 2009, the subject matter of which is incorporated herein by reference.

### BACKGROUND OF THE INVENTION

1. Field of the Invention

The invention relates in general to a complex fluorescent lamp, and more particularly to a durable complex fluorescent lamp.

2. Description of the Related Art

Referring to FIG. 1, a schematic illustration of a conventional light-emitting device is shown. The light-emitting device 100 includes a ballast 110 and a hot cathode fluorescent lamp (HCFL) 120. The ballast 110 is coupled to an alternating-current (AC) voltage source 115 for lighting up the HCFL 120. For example, the ballast 110 is an electronic ballast and used for transforming a frequency of a local AC voltage (110V/220V) outputted by the AC voltage source 115 to perform a pre-heating and lighting operation on the HCFL 120. The HCFL 120 is a T5, T8 or T9 lamp for instance.

A filament of the HCFL 120 is electrified to generate electrons for activating mercury inside the lamp, and then the activated mercury generates a plasma and short-wave ultraviolet rays for irradiating an inner wall of the lamp to emit visible fluorescent light for illumination. Owing that the plasma cannot be generated until the filament is electrified to an enough high temperature, the lifetime of the HCFL 120 is greatly limited by a switching number of the light emitting device 100. The more often the light emitting device 100 is switched on/off, the shorter lifetime, about 3000˜12000 hours, the HCFL 120 has. Therefore, the conventional light emitting device 100 has lower usage efficiency and thus requires further improvement.

### SUMMARY OF THE INVENTION

The invention is directed to a complex fluorescent lamp. An impedance transformer is used to provide a high voltage signal required for lighting up the complex fluorescent lamp such that the complex fluorescent lamp is applicable to the present electronic ballast.

According to an aspect of the present invention, a complex fluorescent lamp is provided. The complex fluorescent lamp comprises at least one cold cathode fluorescent lamp (CCFL) and an impedance transformer. Each of the CCFL has a first electrode and a second electrode. The impedance transformer is coupled to the first electrode and the second electrode for transforming an alternating-current (AC) signal into a high voltage signal to light up the at least one CCFL.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration of a conventional light-emitting device.

FIG. 2 is a schematic illustration of a light-emitting device according to a preferred embodiment of the invention.

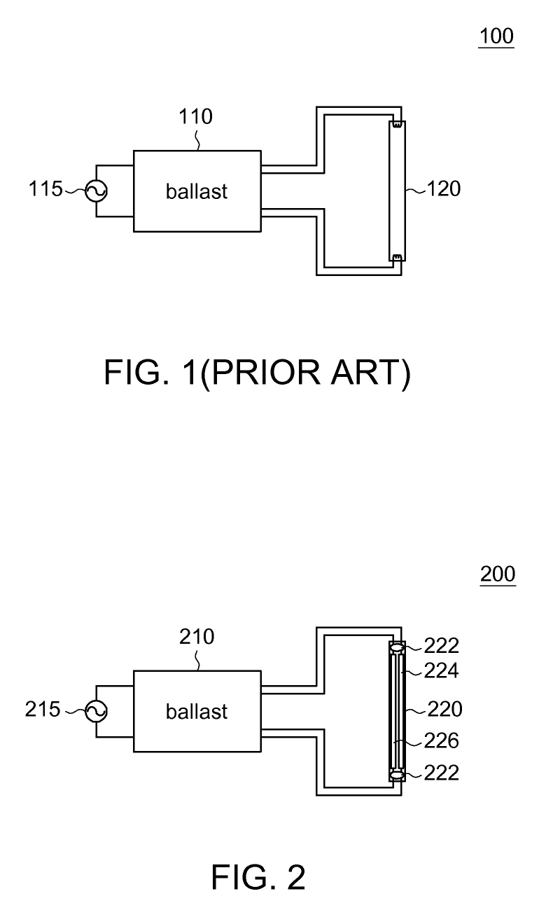

### DETAILED DESCRIPTION OF THE INVENTION

The invention is directed to a complex fluorescent lamp. An impedance transformer is used to provide a high voltage signal required for lighting up the complex fluorescent lamp such that the complex fluorescent lamp can be disposed in a light fixture of the present HCFL.

Referring to FIG. 2, a schematic illustration of a light-emitting device according to a preferred embodiment of the invention is shown. The light-emitting device 200 includes a ballast 210 and a complex fluorescent lamp 220. For example, the ballast 210 is a conventional electronic ballast applied in a HCFL. However, the invention is not limited thereto. The ballast 210 can also be a ballast of a specific design. The ballast 210 is used for transforming a local AC voltage (110V/220V) outputted by an AC voltage source 215 into an AC signal, which has a steady-state voltage lower than 300V. Substantially, the voltage and current of the AC signal are only applicable to the HCFL.

The complex fluorescent lamp 220 includes at least one CCFL and an impedance transformer 222. In FIG. 2, two CCFLs 224 and 226 are exemplified for illustration. However, the number of the CCFLs is not limited thereto. Each of the CCFLs 224 and 226 has a first electrode and a second electrode. As shown in FIG. 2, the impedance transformer 222 is coupled to the first electrodes and the second electrodes of the CCFLs 224 and 226.

The impedance transformer 222 provides an impedance matching effect and transforms the AC signal outputted by the ballast 210 into a high voltage signal to light up the CCFLs 224 and 226. The impedance transformer 222 substantially enables the ballast 210 to achieve an effect of the highest power generation or enough power output. The high voltage signal has a very large amplitude in order to light up the CCFLs 224 and 226. Substantially, the amplitude of the high voltage signal reaches more than one thousand volts at an initial stage, and thus the CCFLs 224 and 226 can be lighted up without need of the conventional pre-heating operation. Following that, the high voltage signal is stabilized to maintain at about 700˜800 volts.

Owing that the impedance transformer 222 can transform the voltage and current of the AC signal provided by the ballast 210 into driving voltage and current required by the CCFLs 224 and 226 inside the complex fluorescent lamp 220, and a feedback signal received by the ballast 210 is also a normal signal, the ballast 210 can enable the CCFLs 224 and 226 to stably emit light for illumination without need a specific design.

In the preferred embodiment of the invention, for example, the CCFLs 224 and 226 are internal electrode type CCFLs or external electrode type CCFLs, but the invention is not limited thereto. If the CCFLs 224 and 226 are external electrode type CCFLs, the insulation layers of electrodes of the CCFLs 224 and 226 can be made of glass, ceramics or other material. Besides, compared to the conventional HCFL, the complex fluorescent lamp 220 uses recyclable solid-state mercury and thus requires less phosphor, and can effectively filter out the UV light harmful to human body, thereby meeting the requirement of environment protection and health.

The complex fluorescent lamp disclosed by the above embodiment of the invention has a number of advantages, a part of which are listed as following:

The complex fluorescent lamp of the invention can be directly disposed in a light fixture of a HCFL to replace the conventional T5, T8 or T9 HCFL without extra cost because it does not need a ballast of a specific design and it has the same light-fixture mechanism as that of the HCFL. Besides, owing that the complex fluorescent lamp has the characteristics of a CCFL, its lifetime is not limited by the switching number of the lamp. The lifetime of the complex fluorescent lamp can reach more than 50000 hours in average, which is more than ten times the lifetime of the T8 or T9 lamp driven by an inductance ballast and more than five times the lifetime of the T5 lamp driven by an electronic ballast.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A complex fluorescent lamp, comprising:
at least one cold cathode fluorescent lamp (CCFL), having a first electrode and a second electrode; and
an impedance transformer, coupled to the first electrode and the second electrode for transforming an alternating-current (AC) signal into a high voltage signal to light up the at least one CCFL.

2. The complex fluorescent lamp according to claim 1, being disposed in a light fixture of a hot cathode fluorescent lamp (HCFL).

3. The complex fluorescent lamp according to claim 1, wherein the at least one CCFL is an internal electrode type CCFL.

4. The complex fluorescent lamp according to claim 1, wherein the at least one CCFL is an external electrode type CCFL.

5. The complex fluorescent lamp according to claim 1, wherein an insulation layer of an electrode of the at least one CCFL is made of glass or ceramics.

6. The complex fluorescent lamp according to claim 1, being driven by an electronic ballast of a HCFL.

7. The complex fluorescent lamp according to claim 1, being driven by a ballast of a specific design.

8. The complex fluorescent lamp according to claim 1, wherein the AC signal is transformed from a local AC voltage by an electronic ballast.
